(19) United States
(12) Patent Application Publication
(10) Pub. No.: US 2003/0142510 A1
(43) Pub. Date: Jul. 31, 2003

(54) Self-illuminating device attachable to an accessory

(76) Inventor: Mao Yongzhong, Yangzhou (CN)

Correspondence Address: MATTHEW A. NEWBOLES, SUITE 250, 75 ENTERPRISE, ALISO VIEJO, CA, 92663, US

(21) Appl. No.: 10/057,680

(22) Filed: Jan. 25, 2002

(51) Int. Cl. F21S 10/02; G09F 13/00

(52) U.S. Cl. 362/570; 362/559; 362/103; 362/812; 40/581; 40/547

(57) ABSTRACT

A self-illuminating device, having a light source part and a light guide part. A light source is enclosed in an enclosure, which further accommodates a power source, to provide a voltage to the light source and an integrated circuit. The integrated circuit adjusts and controls the power source supplied to the light source, so as to control brightness and color of the light source. The light guide part is preferably in a form of a plurality of light guide strips. Each of the light guide strips has one end received in the enclosure and coupled to the light source and the other end extending therefrom. Due to the light guide property, the light received at one end can be transmitted to the exposed other end of the light guide strips. Preferably, the exposed ends are arranged to display a desired pattern, design or logo.

### BACKGROUND OF THE INVENTION

Everyone is aware of the ever-growing problem of increased traffic congestion. In this regard, due to the greater number of vehicles on the roads and streets, substantially greater risk is present for drivers to get into accidents which can cause substantial property and bodily injury.

Contributing to such increased risk is poor visibility. Such factor, however, is common place, and can occur simply by driving in evening hours, or in bad weather. Additionally, increasing the risk of a potential accident is simple human negligence whereby drivers and/or pedestrians simply fail to pay attention to traffic and the like.

Such behavior is especially high in children, who either may not have learned about traffic safety, or are simply not paying attention. Moreover, due to their smaller size, children are difficult—if not impossible—to see, and thus provide little, if any, time for a driver to react to avoid injuring a child. For example, it is well-known that children playing next to busy streets can run out from between parked cars, giving drivers very limited time to apply brakes or steer out of the way.

As another example include bicyclists, which typically share the roads with cars, trucks, and the like, and come in close proximity to fast moving vehicles. As a result, bicyclists become exceptionally vulnerable, and the potential for serious accidents arise to the extent a driver and/or bicyclist are unable to avoid a collision.

While attempts in the art have been made to increase pedestrian/bicyclist visibility, as well as the visibility of certain traffic markings, the same have been met with limited success. The best known of such prior art include reflective materials and strips that are sewn on or adhere to clothing and the like. Problematic with such materials, however, is the fact that the same are not self-illuminating and necessarily require reflection from an on-coming light source in order to produce a reflective effect. Additionally, in the case of children, such materials are typically not configured into decorative designs, characters and the like to thus provide the same with greater appeal. As a result, children are not motivated or otherwise have any desire to wear such protective materials.

Accordingly, there is a substantial need in the art for a self-illuminating device that can be attached to or incorporated within an accessory that can provide illumination that enables the article and/or person carrying or wearing the same to be more easily and readily seen. There is additionally a need in the art for such a self-illuminating device that greatly enhances the visibility and safety of a person or object bearing such device which enables the person or thing to be more easily seen. There is further a need in the art for such a device that can be configured to portray any of a variety of designs, logos, characters and the like which thus provides great appeal to the wearer and/or user, and can further be useful in serving advertising and promotion purposes in addition to enhancing safety.

### SUMMARY OF THE INVENTION

The present invention specifically addresses and alleviates the above-identified deficiencies in the art. In this regard, the present invention provides a self-illuminating device portraying a desired pattern that can be attached on any accessory, such as clothing, or backpacks carried by a pedestrian, or a bicycle or stationary object. Contrary to single, non-stylish light sources or light reflectors with inefficient brightness, the self-illuminated pattern can be designed with any pattern, character, logo and/or slogan for any commercial purpose with sufficient light intensity. Thus, the person, especially if a child, will wear such self-illuminating pattern more willingly, and the attention of drivers on the road will be better caught.

In addition, from a commercial view point, such self-illuminating device can be utilized in a variety of other applications. For example, the device may be worn by an athlete to achieve an advertisement effect. Further, as the self-illuminating device can be designed with any required pattern with various colors, it can also be used in a variety of fashion applications for distinction between individuals.

The self-illuminating device basically comprises a light source and a multiplicity of elongate light-conductive materials, such as glass or optical fibers. One end of the glass fibers is coupled to the light source. The light emitted from the one end of glass fibers will be guided to the respective other ends thereof without great loss of energy. Further, due to the light-guide property inherent in such optical fibers, the light will always travel to the other end without any alignment problem. Preferably, the light source includes a light-weight, low power light emitting diode (LED) able to emit light under different power supplies. The power supply to the light emitting diode preferably includes a battery, such as a normal 3V battery. Further, the other ends of the glass fibers can be fixed and/or arranged into any desired pattern such as a cartoon or animal character, a warning symbol, a slogan, a team or commercial name, or a logo to obtain the amusement, decoration or advertisement effect.

Further, the light source and the light guided material (i.e., optical fibers) are formed of lost cost and light-weight material. Advantageously, the fabrication cost is low. The device is further advantageously light and can be easily attached on any kind of outfit and carrier.

### BRIEF DESCRIPTION OF THE DRAWINGS

These, as well as other features of the present invention, will become more apparent upon reference to the drawings wherein:

FIG. 1 is a front view of the self-illuminating device;

FIG. 2 shows the rear side of the light source part of the self-illuminating device as shown in FIG. 1;

FIG. 3 is an enlarged view showing the front side of the light source part of the self-illuminating device as shown in FIG. 1; and

FIG. 4 is an enlarged view showing the side view of the light source part of the self-illuminating device as shown in FIG. 1.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

The present invention is directed to a self-illuminating device that can be incorporated into clothing or any of a wide variety of articles for that matter to enhance safety and produce a desired means of advertising. Advantageously, by providing a source of illumination, a child, or any other wearer for that matter, whether it be an adult, bicyclist, or the like, will be provided with highly visible means that will enhance the wearer's safety.

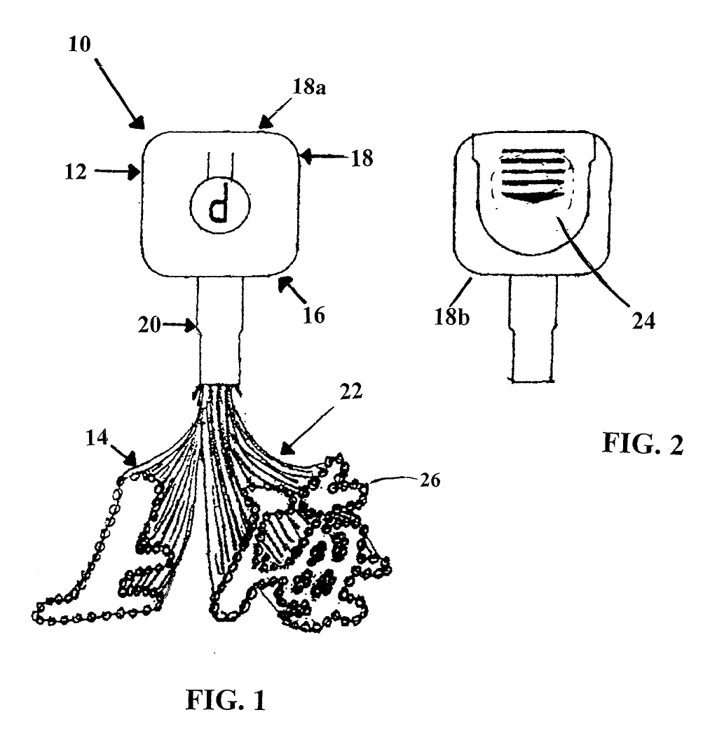

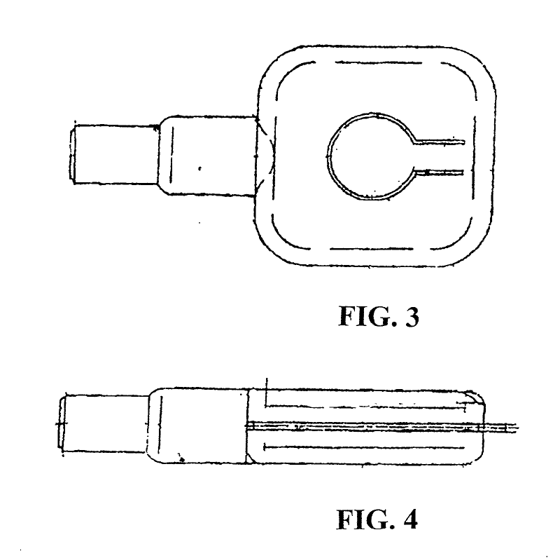

Referring now to the drawings, and initially to FIG. 1, there is shown a schematic drawing of a self-illuminating device 10 constructed in accordance with a preferred embodiment of the present invention. The self-illuminating device 10 has a light source part 12 and a light guide part 14. As shown in FIG. 1, the exterior of the light source part 12 includes an enclosure 16, a switch 18, preferably a button switch, and an extension 20 of the enclosure 16. In this example, the switch 18 is located on a front panel 18a of the enclosure 16. It is appreciated that the location of the switch 18 can be arranged at any place as long as it is easy for the user to access. FIG. 2 shows the rear side of the light source part 12. On the rear panel 18b of the enclosure 16, a lid 24 is attached for equipping and removing the battery of the self-illuminating device. FIG. 3 shows the side view of the light source part 12.

Inside of the enclosure 16, the light source part 12 further comprises a light source, a battery, and a printed circuit board. The light source is selected from those low power emitting devices, such as a light emitting diode that can emit various colors of lights with various brightness. The switch 18 turns on or off the electrical connection between the light source and the battery. A printed circuit board with an integrated circuit (IC) is incorporated to adjust and control the power supplied from the battery to the light source, so as to adjust the brightness and color of the light emitted from the light source. For example, the battery can be a 3V lithium (Li) battery.

The light guide part 14 includes a multiplicity of light guide strips 22, for example, optical or glass fiber strips, with one end inside of the enclosure 16 connected to the light source and the other end 26 extending therefrom. The light guide strips 22 are bound by the extension 20, which is preferably made of copper tube, and received in the enclosure 16. As mentioned above, the light guide property of the light guide part 14 enables the light emitted from the light source received at the end anchored to enclosure 16 to travel to the exposed other end 26 without significant loss. The light is then emitted from each respective exposed end of the light guide strips 22, thus causing the exposed end of each light guide strip 22 to illuminate.

The exposed ends 26 of the light guide strips 22 can be fixed and arranged in any pattern as may desired. For example, such exposed ends 26 can be designed in a cartoon or animal character and attached to a hat, school bag, backpack or jacket of a child. Currently, most of the prior art devices on the market for increasing noticability and the like are based on light reflection. That is, such devices do not illuminate themselves. Instead, only when there is an external light source (e.g., the head lights of a car) incident on the device, the warning sign can be seen. Under certain circumstances, however, such as when the head light of the car has not been turned on, which occurs very often in the twilight, or the angle does not allow head light incident on the reflection part of the device, the warning sign is ineffective.

Separate and apart from the safety aspects of the present invention, which include those aspects discussed above whereby the device is utilized in connection with clothing, backpacks, and the like, are a number of other uses. In this respect, the exposed ends 26 maybe affixed to or arranged in any of a variety of configurations as maybe desired for a wide variety of the applications. In one context, such as a sports game, the ends 26 maybe designed according to the logo of a team. In the example as shown in FIG. 1, the exposed end of the light guide part 14 shows two Chinese Characters of “shang” and “hai” (which means the city Shanghai). In another embodiment of the invention, the exposed ends 26 of the light guide strips 22 can be threaded through and fixed or glued on a signboard, such that the illuminating pattern can be displayed on the signboard. Further, more than one light source can be incorporated in the light source part 12 to provide different colors or brightness.

In addition to a flashing warning sign, design or advertising logo, the self-illuminating device can also be attached on the outfit as an ornament, or attached on any accessory for distinction of individuals. For example, the device of the present invention maybe incorporated as part of a uniform or some type of work attire to thus enable customers to easily recognize a particular attending service person. In this regard, it is contemplated that the device of the present invention maybe utilized in the food service industry, particularly with respect to uniforms or attire worn by waiters and waitresses, hostesses, bartenders, and the like to thus present a novel, attention generating appearance.

Indeed, each of the features and embodiments described herein can be used by itself, or in combination with one or more of other features and embodiment. Thus, the invention is not limited by the illustrated embodiment but is to be defined by the following claims when read in the broadest reasonable manner to preserve the validity of the claims.

What is claimed is:

1. A self-illuminating device, comprising:
a light source;
a plurality of light guide strips, each with one first end coupled to the light source, and a second end arranged and fixed in position and operative to emit light from said light source therefrom, said second ends being cooperatively arranged to define a pattern.

2. The self-illuminating device according to claim 1, wherein the light source includes at least one light emitting diode.

3. The self-illuminating device according to claim 2, wherein the light emitting diode is driven by a battery.

4. The self-illuminating device according to claim 1, wherein an integrated circuit is incorporated to adjust brightness and color of the light source.

5. The self-illuminating device according to according to claim 1, wherein the self-illuminating device is attached on an accessory worn or carried by a user.

6. The self-illuminating device according to claim 1, wherein the light guide strips comprise a plurality of glass fiber strips.

7. A self-illuminating device, comprising: a light source part, including:
an enclosure;
a light source, enclosed in the enclosure;
a power source, enclosed in the enclosure to provide a voltage to the light source;
an integrated circuit, to adjust and control the power source supplied to the light source, so as to control brightness and color of the light source; and
a light guide part, comprising a plurality of light guide strips each with a first end received in the enclosure and coupled to the light source and a second end exposed and arranged in fixed position such that in use, said second ends cooperatively define an illuminated pattern when light is transmitted thereto from said light source.

8. The self-illumination device according to claim 7, wherein the light source comprises at least one light emitting diode.

9. The self-illuminating device according to claim 8, wherein the exposed ends of the light guide strips are glued into said pattern.

10. The self-illuminating device according to claim 8, wherein the light guide strips include a plurality of glass fibers.

11. An accessory, attached with a self-illuminating pattern that comprises:
a light source, to provide a light; and
a light guide part with one end connected to the light source to guide the light into a plurality of points thereof that construct the self-illuminating pattern.

12. The accessory according to claim 11, wherein the light source includes at least a light emitting diode.

13. The accessory according to claim 11, wherein the light guide part comprises a plurality of glass fibers.

14. The accessory according to claim 11 includes a hat.

15. The accessory according to claim 11 includes a visor.

16. The accessory according to claim 11 includes an outfit.

17. The accessory according to claim 11 includes a signboard.

18. The device of claim 7 wherein said second end defines a pattern selected from the group consisting of a warning sign, a logo and a decorative design.

19. The device of claim 7 wherein said device is incorporated into an item of wearing apparel.

20. A method of advertising and promoting a logo comprising the steps:
a) providing a self-illuminating device, wherein said device comprises:
a light source part, including:
an enclosure;
a light source, enclosed in the enclosure;
a power source, enclosed in the enclosure to provide a voltage to the light source;
an integrated circuit, to adjust and control the power source supplied to the light source, so as to control brightness and color of the light source;
a light guide part, comprising a plurality of light guide strips each with a first end received in the enclosure and coupled to the light source and a second end exposed and arranged in fixed position such that in use, said second ends cooperatively define an illuminated logo when light is transmitted thereto from said light source; and
b) integrating said device in step (a) into an item of wearing apparel such that said logo can be seen from said wearing apparel item when said wearing apparel is worn; and
c) wearing said wearing apparel in step (b).

21. A safety garment for enhancing the safety of an individual wearing the same comprising:
an item of wearing apparel selected from the group consisting of a hat, pair of pants, shirt, jacket, socks and shoes; and
b) a self-illuminating device incorporated into said wearing apparel, said self-illuminating device comprising:
a light source part, including:
an enclosure;
a light source, enclosed in the enclosure;
a power source, enclosed in the enclosure to provide a voltage to the light source; and
an integrated circuit, to adjust and control the power source supplied to the light source, so as to control brightness and color of the light source; and
a light guide part, comprising a plurality of light guide strips each with a first end received in the enclosure and coupled to the light source and a second end exposed and arranged in fixed position such that in use, said second ends cooperatively define an illuminated pattern when light is transmitted thereto from said light source.
